(19) United States
(12) Patent Application Publication
(10) Pub. No.: US 2026/0350956 A1
(43) Pub. Date: Nov. 5, 2026

(54) OBJECT DETECTION DEVICE, OBJECT DETECTION METHOD, AND OBJECT DETECTION PROGRAM

(71) Applicant: NIPPON TELEGRAPH AND TELEPHONE CORPORATION, Tokyo (JP)

(72) Inventors: Yuko IINUMA, Tokyo (JP); Hiroyuki UZAWA, Tokyo (JP); Saki HATTA, Tokyo (JP); Shuhei YOSHIDA, Tokyo (JP); Ken NAKAMURA, Tokyo (JP); Daisuke KOBAYASHI, Tokyo (JP); Yusuke HORISHITA, Tokyo (JP); Yuya OMORI, Tokyo (JP)

(73) Assignee: NIPPON TELEGRAPH AND TELEPHONE CORPORATION, Tokyo (JP)

(21) Appl. No.: 18/997,536

(22) PCT Filed: Jul. 28, 2022
(86) PCT No.: PCT/JP2022/029165

§ 371 Date: Jan. 22, 2025

(51) Int. Cl. G06V 10/25; G06V 10/774

(52) U.S. Cl. CPC G06V 10/25; G06V 10/774; G06V 2201/07

(57) ABSTRACT

An estimation unit (41) estimates a density map of a target image to be a target of object detection by using a density estimation model (31) that has learned, as correct answer data, a density map indicating a probability density at which an object is present at each position of an image, the density map being created by assigning a normal distribution having a variance corresponding to a size of the object to a position corresponding to a region of the object in a learning image in which the region of the object is known, an extraction unit (42) extracts a region corresponding to a position where a probability density is equal to or higher than a threshold in the density map as a region to be a target of the object detection, and a detection unit (43) detects an object by applying an object detection model (32) to a region of the target image corresponding to the extracted region.

### TECHNICAL FIELD

The technology disclosed herein relates to an object detection device, an object detection method, and an object detection program.

### BACKGROUND ART

The object detection device is a device that estimates a class of an object such as a person or an automobile included in an input image, coordinate information of a rectangular bounding box surrounding a region of the object in the image, and reliability of a detection result. In recent years, a plurality of object detection models using deep learning has been proposed. As an object detection model based on deep learning, You Only Look Once (YOLO), RetinaNet, and the like that collectively infer a bounding box and a class of an object have been proposed (Non Patent Literatures 1 and 2). Further, there have been proposed an R-CNN that separately performs detection of an object candidate region and classification of an object class, a Faster R-CNN obtained by improving the R-CNN, and the like (Non Patent Literatures 3 and 4).

Further, when object detection is performed from a high-definition image or video such as 4K or 8K, for example, in YOLO v5, the input image size to the object detection model is limited to 1536×1536 at the maximum, and thus a high definition image cannot be input as it is. Accordingly, a method has been proposed in which an input high definition image is divided according to the input image size of the object detection model, results of object detection are aggregated from each divided image, and the results are output as results of object detection from the entire image. As this method, some methods have been proposed by a method of dividing an image. For example, a method has been proposed in which a group of images equally divided in accordance with the input image size of the object detection model and an image reduced as a whole are each input to the object detection model. In this method, coordinate information of the obtained bounding box is scaled, detection results of the divided images and the reduced image are combined, and a final result is output (Non Patent Literature 5).

In addition, a method has been proposed in which a distribution of a region where an object exists is estimated in an image by using probability density estimation or cluster detection, and only a region where an object is predicted to exist is cut out and an object detection model is applied (Non Patent Literatures 6 and 7).

### CITATION LIST

### Non Patent Literature

Non Patent Literature 1: J. Redmon et al., “You Only Look Once: Unified, Real-Time Object Detection,” 2016 IEEE Conference on Computer Vision and Pattern Recognition (CVPR), 2016, pp. 779-788.
Non Patent Literature 2: T.-Y. Lin et al., “Focal Loss for Dense Object Detection,” 2017 IEEE International Conference on Computer Vision (ICCV), 2017. pp. 2999-3007.
Non Patent Literature 3: R. Girshick et al., “Rich Feature Hierarchies for Accurate Object Detection and Semantic Segmentation,” 2014 IEEE Conference on Computer Vision and Pattern Recognition, 2014, pp. 580-587.
Non Patent Literature 4: S. Ren et al., “Faster R-CNN: Towards Real-Time Object Detection with Region Proposal Networks,” in IEEE Transactions on Pattern Analysis and Machine Intelligence, vol. 39, no. 6, pp. 1137-1149, 1 Jun. 2017.
Non Patent Literature 5: H. Uzawa et al., “High-definition object detection technology based on AI inference scheme and its implementation”, IEICE Electronics Express, 2021, Volume 18, Issue 22, Pages 20210323.
Non Patent Literature 6: C. Li et al., “Density Map Guided Object Detection in Aerial Images,” 2020 IEEE/CVF CVPRW, 2020, pp. 737-746.
Non Patent Literature 7: F. Yang et al., “Clustered Object Detection in Aerial Images,” 2019 IEEE/CVF ICCV, 2019, pp. 8310-8319.

### SUMMARY OF INVENTION

### Technical Problem

In a method of equally dividing a high definition image and performing object detection as in the method described in Non Patent Literature 5, it is not possible to selectively apply object detection to each divided image. Accordingly, when the number of divided images increases as the resolution of the input image increases, the amount of calculation for object detection increases. On the other hand, in a method based on cluster detection or probability density estimation as in the methods described in Non Patent Literatures 6 and 7, a region to which object detection is applied in an image is narrowed down, and thus the amount of calculation may be significantly reduced depending on the image.

However, the conventional method for detecting an object on the basis of the result of the probability density estimation has a problem that a relatively large object in an input image cannot be detected.

The disclosed technology has been made in view of the above points, and an object thereof is to reduce detection omission of a relatively large object in an input image.

### Solution to Problem

A first aspect of the present disclosure is an object detection device including an estimation unit that estimates a density map of a target image to be a target of object detection by using a density estimation model that has learned, as correct answer data, a density map indicating a probability density at which an object is present at each position of an image, the density map being created by assigning a predetermined density distribution having a variance corresponding to a size of the object to a position corresponding to a region of the object in a learning image in which the region of the object is known, an extraction unit that extracts a region corresponding to a position where a probability density is equal to or higher than a threshold in the density map estimated by the estimation unit as a region to be a target of the object detection, and a detection unit that detects an object by applying an object detection model generated in advance by machine learning for detecting an object from an image to a region of the target image corresponding to the region extracted by the extraction unit.

A second aspect of the present disclosure is an object detection method including estimating, by an estimation unit, a density map of a target image to be a target of object detection by using a density estimation model that has learned, as correct answer data, a density map indicating a probability density at which an object is present at each position of an image, the density map being created by assigning a predetermined density distribution having a variance corresponding to a size of the object to a position corresponding to a region of the object in a learning image in which the region of the object is known, extracting, by an extraction unit, a region corresponding to a position where a probability density is equal to or higher than a threshold in the density map estimated by the estimation unit as a region to be a target of the object detection, and detecting, by a detection unit, an object by applying an object detection model generated in advance by machine learning for detecting an object from an image to a region of the target image corresponding to the region extracted by the extraction unit.

A third aspect of the present disclosure is an object detection program causing a computer to function as each unit constituting the above-described object detection device.

### Advantageous Effects of Invention

According to the disclosed technology, it is possible to reduce detection omission of a relatively large object in an input image.

### BRIEF DESCRIPTION OF DRAWINGS

FIG. 1 is a block diagram illustrating a hardware configuration of an object detection device.

FIG. 2 is a block diagram illustrating a functional configuration of the object detection device.

FIG. 3 is a diagram for describing creation of correct answer data of a density map.

FIG. 4 is a diagram for describing improvement in accuracy of creating correct answer data of a density map.

FIG. 5 is a diagram for describing improvement in accuracy of an estimation result of a density map.

FIG. 6 is a flowchart illustrating an example of creation processing.

FIG. 7 is a flowchart illustrating an example of model learning processing.

FIG. 8 is a flowchart illustrating an example of detection processing.

FIG. 9 is a flowchart illustrating an example of rectangular region extraction processing according to the first embodiment.

FIG. 10 is a flowchart illustrating an example of rectangular region extraction processing according to the second embodiment.

### DESCRIPTION OF EMBODIMENTS

Hereinafter, an example of an embodiment of the disclosed technique will be described with reference to the drawings. Note that, in the drawings, the same or equivalent components and portions are denoted by the same reference signs. Further, dimensional ratios in the drawings are exaggerated for convenience of description, and may be different from actual ratios.

### <Problems of Conventional Method Based on Probability Density Estimation>

Before describing details of each embodiment, the problem that a relatively large object in an input image cannot be detected in the conventional method based on probability density estimation will be described.

For learning of a density estimation model for estimating a density map indicating a probability density at which an object is present at each position of an image, correct answer data of a probability density map created on the basis of annotation of an object detection data set is used. In the annotation for object detection, a class of an object in the image, coordinate information of a bounding box (hereinafter, also referred to as a “Bbox”), and vertical and horizontal lengths of the Bbox are given.

In the conventional technique, an average H of vertical lengths and an average W of horizontal lengths of the Bbox are calculated for each class of the object, and a normal distribution in which V expressed in the following Formula (1) is a variance is created using these values. In the conventional technique, this normal distribution is regarded as a probability density distribution of an object centered on center coordinates of the Bbox, and these are superimposed to create correct answer data of the density map.

$$\begin{matrix}Formula 1 & \\ {V}^{′} = \frac{\sqrt{{W}^{2} + {H}^{2}}}{2} & ( 1 )\end{matrix}$$

For example, in the case of an image in which an object is captured from an oblique angle like a surveillance camera, even if the object is of the same class, an object existing far from a camera that captures the image is small, and an object existing near the camera appears large. Thus, in the creation method for the correct answer data of the density map of the above-described conventional method, only a much smaller probability density distribution than the size is allocated to a relatively large object close to the camera on the image. When the density estimation model learned using the correct answer data of the density map created in this way is used, it is not possible to estimate an appropriate probability density distribution for a relatively large object on the image. As a result, a region where an object is predicted to be present cannot be appropriately extracted, a relatively large object is missed on an image, and detection omission occurs in object detection.

In the following embodiments, a method for reducing detection omission of a relatively large object in an input image is proposed.

### First Embodiment

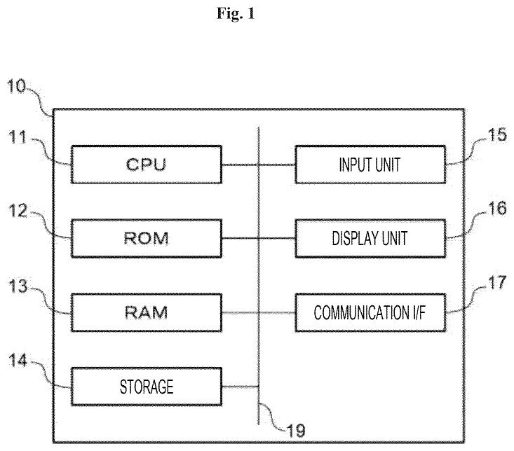

FIG. 1 is a block diagram illustrating a hardware configuration of an object detection device 10 according to the first embodiment. As illustrated in FIG. 1, the object detection device 10 includes a central processing unit (CPU) 11, a read only memory (ROM) 12, a random access memory (RAM) 13, a storage 14, an input unit 15, a display unit 16, and a communication interface (I/F) 17. The components are connected to be able to communicate with each other via a bus 19.

The CPU 11 is a central processing unit, and executes various programs and controls each of the units. That is, the CPU 11 reads a program from the ROM 12 or the storage 14, and executes the program using the RAM 13 as a work area. The CPU 11 controls each of the components described above and performs various types of operation processing according to the program stored in the ROM 12 or the storage 14. In the present embodiment, the ROM 12 or the storage 14 stores an object detection program for executing creation processing, model learning processing, and detection processing to be described later.

The ROM 12 stores various programs and various types of data. The RAM 13 temporarily stores a program or data as a work area. The storage 14 includes a storage device such as a hard disk drive (HDD) or a solid state drive (SSD), and stores various programs including an operating system and various data.

The input unit 15 includes a pointing device such as a mouse and a keyboard and is used to perform various inputs. The display unit 16 is, for example, a liquid crystal display, and displays various types of information. The display unit 16 may function as the input unit 15 by employing a touchscreen system. The communication I/F 17 is an interface for communicating with other devices. For the communication, for example, a wired communication standard such as Ethernet (registered trademark) or FDDI or a wireless communication standard such as 4G, 5G, or Wi-Fi (registered trademark) is used.

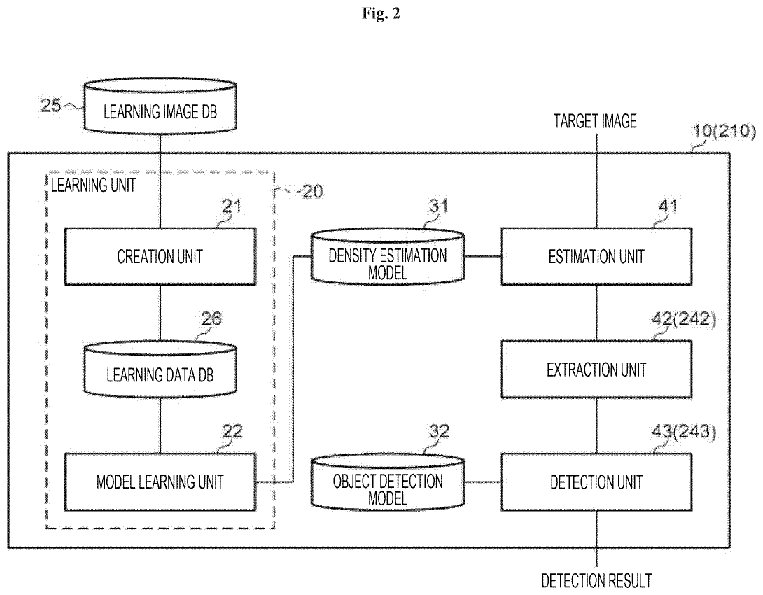

Next, a functional configuration of the object detection device 10 according to the first embodiment will be described. FIG. 2 is a block diagram illustrating an example of the functional configuration of the object detection device 10. As illustrated in FIG. 2, the object detection device 10 includes a learning unit 20, an estimation unit 41, an extraction unit 42, and a detection unit 43 as a functional configuration. The learning unit 20 further includes a creation unit 21 and a model learning unit 22. Each functional configuration is achieved by the CPU 11 reading the object detection program stored in the ROM 12 or the storage 14, loading the object detection program in the RAM 13, and executing the object detection program.

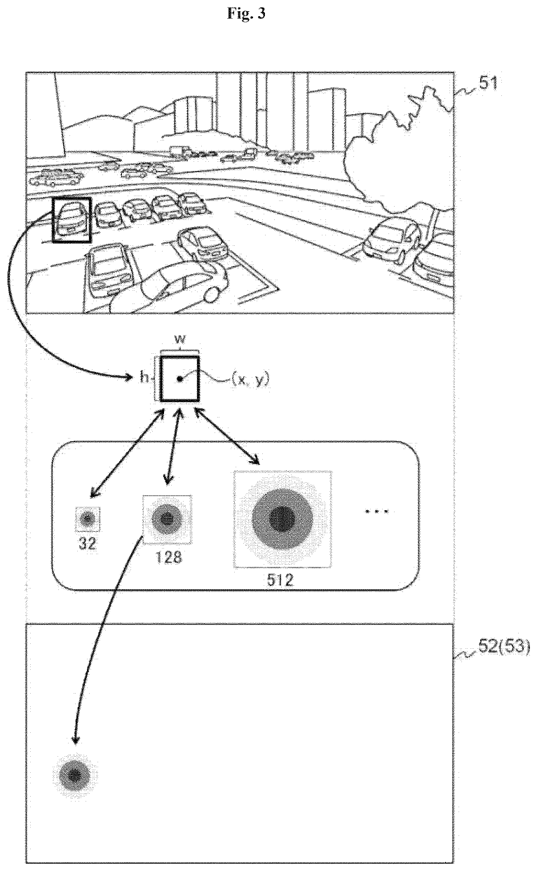

The creation unit 21 acquires the learning image having a known region of an object stored in the learning image DB 25. As illustrated in the upper diagram of FIG. 3, an annotation of an object is added to each learning image 51. The annotation includes coordinate information (x, y) of predetermined coordinates (for example, center coordinates) of a Bbox that is a region surrounding an object in the image, and a vertical length h and a horizontal length w of the Bbox. Note that, in the example of FIG. 3, only a Bbox indicating a region of one object in the learning image 51 is illustrated, but actually, annotations are added to all objects in the image.

The creation unit 21 creates, from the learning image 51, correct answer data of a density map indicating a probability density that an object exists at each position of the image. Specifically, the creation unit 21 creates the correct answer data of the density map by assigning a predetermined density distribution having a variance corresponding to the size of an object to a position corresponding to the region of the object in the learning image 51.

More specifically, the creation unit 21 prepares the density map 52 having the same size as the learning image 51 and having all pixels initialized to 0. Furthermore, as an example of the density distribution, the creation unit 21 prepares a plurality of normal distributions having different variances as illustrated in the middle diagram of FIG. 3. In the example of FIG. 3, the numbers 32, 128, and 512 correspond to respective variances of normal distributions. That is, each normal distribution is a normal distribution distributed in a range in which the center of the range corresponding to each size of 32×32 pixels, 128×128 pixels, and 512×512 pixels is set as an average. Note that the above range is an example and can be arbitrarily set. In addition, there may be many types of normal distributions to be prepared. The creation unit 21 handles this normal distribution as a probability density distribution for each object.

As illustrated in the middle and lower diagrams of FIG. 3, the creation unit 21 creates correct answer data 53 of the density map by selecting the normal distribution in which a difference between a value corresponding to the size of the object and a value of the variance of each normal distribution is minimized from among the plurality of normal distributions, and assigning the selected normal distribution to the density map 52. Specifically, the creation unit 21 acquires the vertical length h and the horizontal length w of the Bbox for each object from the annotation added to the learning image 51, and calculates V represented by the Formula (2).

$$\begin{matrix}Formula 2 & \\ V = \frac{\sqrt{{w}^{2} + {h}^{2}}}{2} & ( 2 )\end{matrix}$$

The creation unit 21 compares the calculated V with the variance of each of the plurality of prepared normal distributions, and selects a normal distribution having a variance that minimizes a difference from V. The creation unit 21 acquires the center coordinates (x, y) of the Bbox from the annotation added to the learning image 51, sets the acquired (x, y) as the average of the normal distribution, regards the normal distribution as the probability density distribution of the object, and assigns the normal distribution to the density map 52. Thus, each pixel of the density map 52 to which the normal distribution is assigned has a probability density value corresponding to the assigned normal distribution. The example of FIG. 3 illustrates an example in which the second normal distribution from the left is selected among the plurality of normal distributions, and the selected normal distribution is assigned to the corresponding position of the density map 52. The creation unit 21 repeatedly performs processing of selecting a normal distribution and assigning the normal distribution to the density map 52 for all objects included in the learning image 51, that is, all boxes, and creates the correct answer data 53 of the final density map.

The creation unit 21 creates the correct answer data 53 of the density map for each of the plurality of learning images 51 stored in the learning image DB 25, and stores a pair of the learning image 51 and the correct answer data 53 of the density map in a learning data DB 26 as learning data.

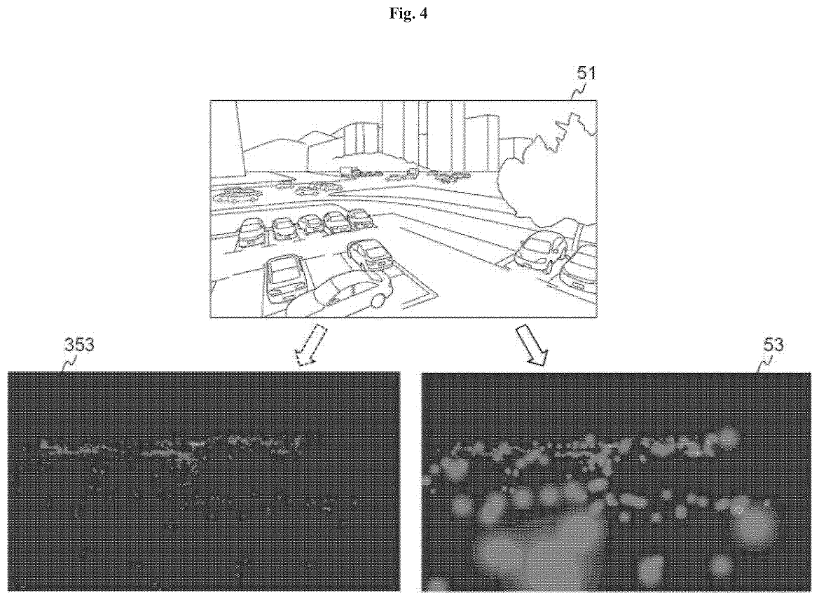

FIG. 4 illustrates a comparison between the correct answer data 53 of the density map created by the creation unit 21 of the present embodiment and the correct answer data 353 of the density map created by the conventional method. In the correct answer data 353 of the density map created by the conventional method, a probability density distribution of the same size is assigned to both the automobile appearing large on the near side and the automobile having a small distant view. On the other hand, in the correct answer data 53 of the density map created by the creation unit 21 of the present embodiment, a probability density distribution having a large variance and covering the entire object is assigned to a large object.

The model learning unit 22 learns the density estimation model 31 that estimates the density map for the input image by using the learning data stored in the learning data DB 26. Specifically, the model learning unit 22 updates the parameters of the density estimation model 31 so as to minimize an error between an estimation result of the density map obtained by inputting the learning image 51 to the density estimation model 31 and the correct answer data 53 of the density map paired with the learning image 51. The model learning unit 22 stores the learned density estimation model 31 in a predetermined storage area of the object detection device 10.

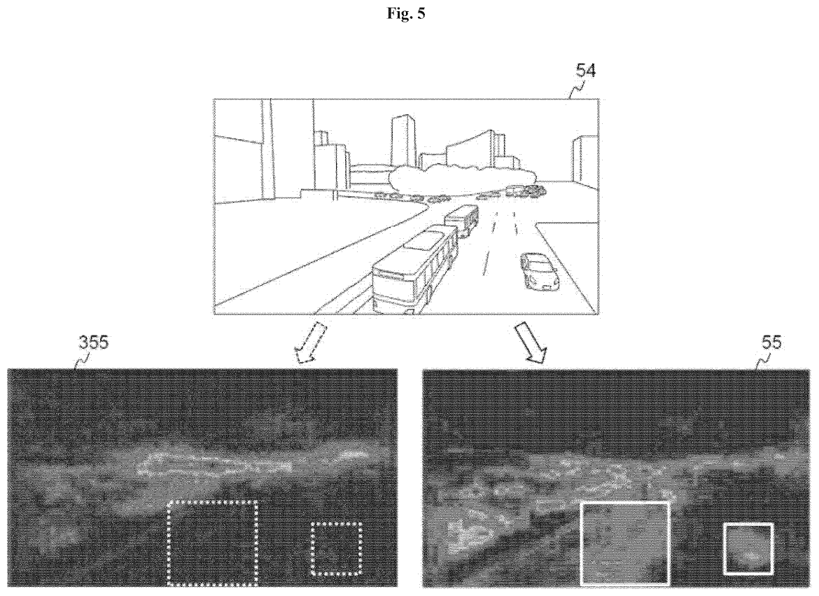

The estimation unit 41 acquires a target image to be a target of object detection. The estimation unit 41 estimates the density map of the target image using the density estimation model 31 learned by the learning unit 20. FIG. 5 illustrates a comparison between the density map 55 estimated by the estimation unit 41 of the present embodiment and the density map 355 estimated by the conventional method for the target image 54. In the conventional method, the probability density distribution of a bus or an automobile in a near view cannot be estimated (dotted white frame portion in the lower left of FIG. 5). On the other hand, in the present embodiment, by using the density estimation model 31 learned using the correct answer data 53 created by the creation unit 21, it can be seen that the probability density distribution of a bus or an automobile in a near view, which cannot be estimated by the conventional method, can be estimated (solid white frame portion in the lower right of FIG. 5). Thus, in the present embodiment, it is possible to prevent detection omission of a relatively large object on an image.

The extraction unit 42 extracts a region corresponding to a position where the probability density is equal to or higher than a threshold in the density map 55 estimated by the estimation unit 41 for the target image 54 as a region to be a target of object detection. Specifically, the extraction unit 42 generates a mask image in which a value of a pixel having a probability density equal to or higher than the threshold is set to 1 and a value of a pixel having a probability density less than the threshold is set to 0 in the density map 55 estimated by the estimation unit 41. Then, the extraction unit 42 extracts a rectangular region including a portion in which pixels having a value of 1 are continuous in the generated mask image and having a size corresponding to an input size to the object detection model 32 to be described later as the region to be the target of the object detection. The extraction unit 42 assigns an ID that is identification information to each of the extracted rectangular regions, and passes rectangular information including the ID, the center coordinates of the rectangular region, and the vertical length and the horizontal length of the rectangular region to the detection unit 43.

The detection unit 43 detects an object by applying the object detection model 32 to a region of the target image 54 corresponding to the rectangular region extracted by the extraction unit 42 on the basis of the rectangle information passed from the extraction unit 42. The object detection model 32 is generated in advance by machine learning in order to detect an object from an image, and is stored in a predetermined storage area of the object detection device 10. The object detection model 32 outputs metadata including at least a class of an object included in the input image, a Bbox indicating a region of the object, and reliability of detection. The detection unit 43 outputs the metadata output from the object detection model 32 as a detection result.

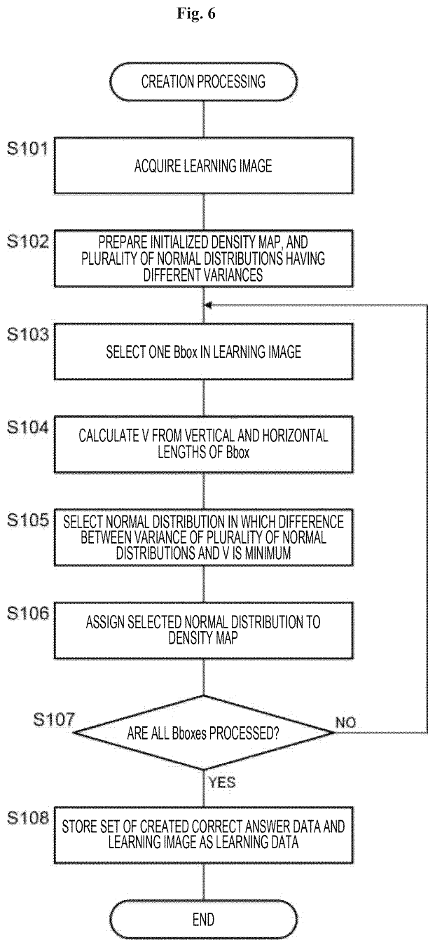

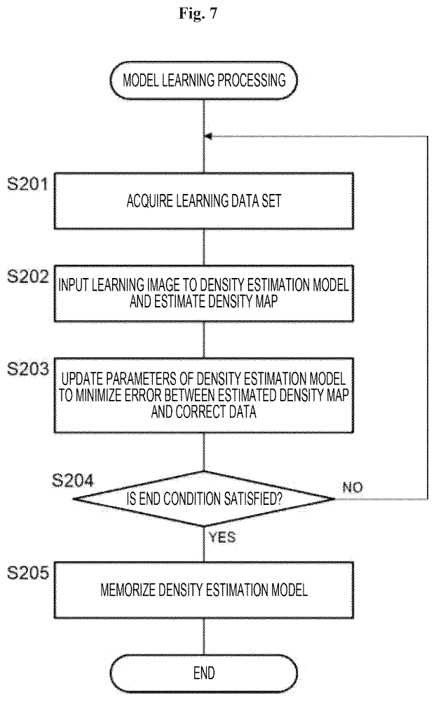

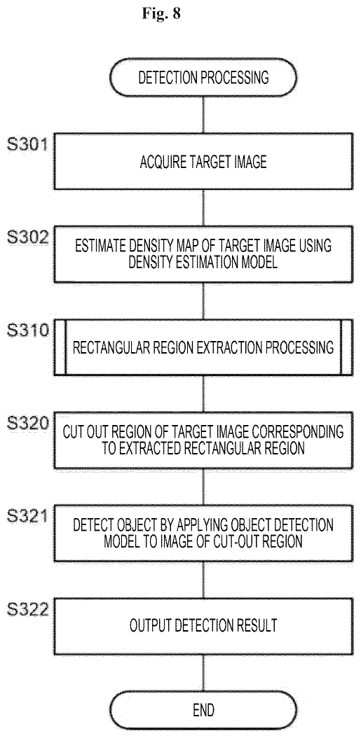

Next, an operation of the object detection device 10 according to the first embodiment will be described. FIG. 6 is a flowchart illustrating a flow of creation processing by the object detection device 10. Further, FIG. 7 is a flowchart illustrating a flow of model learning processing by the object detection device 10. Further, FIG. 8 is a flowchart illustrating a flow of detection processing by the object detection device 10. The CPU 11 reads the object detection program from the ROM 12 or the storage 14, loads the object detection program in the RAM 13, and executes the object detection program, whereby each of the creation processing, the model learning processing, and the detection processing is performed.

First, the creation processing illustrated in FIG. 6 will be described.

In step S101, the CPU 11, as the creation unit 21, acquires one learning image 51 from the learning image DB 25. Next, in step S102, the CPU 11, as the creation unit 21, prepares a density map having the same size as the learning image 51 and having all pixels initialized to 0, and a plurality of normal distributions having different variances.

Next, in step S103, the CPU 11, as the creation unit 21, selects one Bbox for which the following processing is unprocessed among the Bboxes included in the learning image 51. Next, in step S104, the CPU 11, as the creation unit 21, calculates V in the above Expression (2) from the vertical length h and the horizontal length w of the selected Bbox.

Next, in step S105, the CPU 11, as the creation unit 21, selects a normal distribution having a variance that minimizes the difference between the calculated V and the variance of each of the plurality of prepared normal distributions. Next, in step S106, the CPU 11, as the creation unit 21, assigns pixels of the density map 52 corresponding to the center coordinates (x, y) of the Bbox to the density map 52 as an average of the selected normal distribution.

Next, in step S107, the CPU 11, as the creation unit 21, determines whether or not all the Bboxes included in the learning image 51 have been processed. If all the Bboxes have been processed, the process proceeds to step S108, and if there is an unprocessed Bbox, the process returns to step S103. In step S108, the CPU 11, as the creation unit 21, stores a pair of the correct answer data 53 of the created density map and the learning image 51 in the learning data DB 26 as learning data, and the creation process ends.

The CPU 11, as the creation unit 21, executes the above-described creation processing for each of the plurality of learning images 51 stored in the learning image DB 25.

Next, the model learning processing illustrated in FIG. 7 will be described.

In step S201, the CPU 11, as the model learning unit 22, acquires a learning data set including a plurality of pieces of learning data from the learning data DB 26. Next, in step S202, the CPU 11, as the model learning unit 22, inputs the learning image 51 to the density estimation model 31, and estimates the density map. Next, in step S203, the CPU 11, as the model learning unit 22, updates the parameters of the density estimation model 31 so as to minimize an error between the estimated density map and the correct answer data 53 of the density map.

Next, in step S204, the CPU 11, as the model learning unit 22, determines whether or not the end condition of learning is satisfied. For example, it is determined that the learning end condition is satisfied when the parameter update is repeated a predetermined number of times, when the error is equal to or less than a predetermined value, when a difference between a previous error and a current error is equal to or less than a predetermined value, or the like. If the end condition is satisfied, the process proceeds to step S205, and if the end condition is not satisfied, the process returns to step S201. In step S205, the CPU 11, as the model learning unit 22, stores the learned density estimation model 31 in a predetermined storage area of the object detection device 10, and the model learning processing ends.

Next, detection processing illustrated in FIG. 8 will be described.

In step S301, the CPU 11 acquires, as the estimation unit 41, the target image 54 as a target of object detection. Next, in step S302, the CPU 11 estimates the density map 55 of the target image 54 using the density estimation model 31 learned by the learning unit 20 as the estimation unit 41.

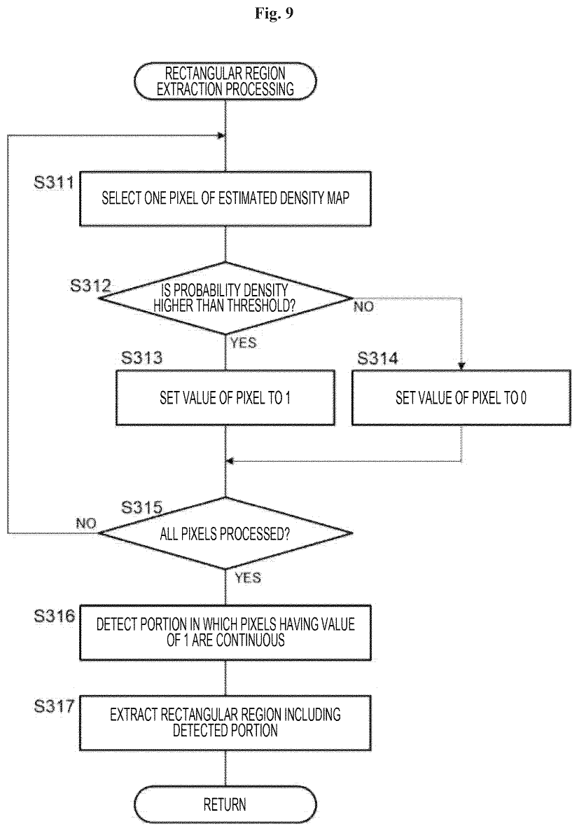

Next, in step S310, the CPU 11 executes rectangular region extraction processing as the extraction unit 42. Here, rectangular region extraction processing will be described with reference to FIG. 9.

In step S311, the CPU 11 selects, as the extraction unit 42, one pixel for which the following processing is unprocessed among the pixels of the estimated density map 55. As the extraction unit 42, for example, the CPU 11 selects pixels in order from the left to the right and from the top to the bottom from the upper left pixel of the density map 55.

Next, in step S312, the CPU 11, as the extraction unit 42, determines whether or not the probability density of the selected pixel is equal to or higher than a predetermined threshold. If the probability density is equal to or higher than the threshold, the process proceeds to step S313, and if the probability density is less than the threshold, the process proceeds to step S314. In step S313, the CPU 11, as the extraction unit 42, sets the value of the pixel to 1, and in step S314, the CPU 11, as the extraction unit 42, sets the value of the pixel to 0.

Next, in step S315, the CPU 11, as the extraction unit 42, determines whether or not all the pixels of the density map 55 have been processed. If all the pixels have been processed, the process proceeds to step S316, and if there is an unprocessed pixel, the process returns to step S311.

In step S316, the CPU 11, as the extraction unit 42, detects a portion in which pixels having a value of 1 are continuous in the mask image generated by the processing in steps S313 and S314. Next, in step S317, the CPU 11, as the extraction unit 42, extracts a rectangular region including the detected portion and having a size corresponding to the size of the input image to the object detection model 32. Then, the CPU 11, as the extraction unit 42, assigns an ID to each of the extracted rectangular regions, passes rectangle information including the ID, the center coordinates of the rectangular region, and the vertical length and the horizontal length of the rectangular region to the detection unit 43, and returns to the detection processing (FIG. 8).

Next, in step S320, the CPU 11, as the detection unit 43, cuts out the region of the target image 54 corresponding to the rectangular region extracted by the extraction unit 42 on the basis of the rectangle information passed from the extraction unit 42. Next, in step S321, the CPU 11, as the detection unit 43, detects an object by applying the object detection model 32 to the image of the cut-out region. Next, in step S322, the CPU 11, as the detection unit 43, outputs a detection result, and the detection process ends.

As described above, the object detection device according to the first embodiment estimates a density map of a target image to be a target of object detection by using a density estimation model that has learned, as correct answer data, a density map indicating a probability density at which an object is present at each position of an image, the density map being created by assigning a predetermined density distribution having a variance corresponding to a size of the object to a position corresponding to a region of the object in a learning image in which the region of the object is known, extracts a region corresponding to a position where a probability density is equal to or higher than a threshold in the estimated density map as a region to be a target of the object detection, and detects an object by applying an object detection model generated in advance by machine learning for detecting an object from an image to a region of the target image corresponding to the extracted region. Thus, detection omission of a relatively large object in the input image can be reduced.

### Second Embodiment

Next, the second embodiment will be described. Note that, in the object detection device according to the second embodiment, the components similar to those of the object detection device 10 according to the first embodiment are denoted by the same reference numerals, and a detailed description thereof will be omitted. Further, since the hardware configuration of the object detection device according to the second embodiment is similar to the hardware configuration of the object detection device 10 according to the first embodiment illustrated in FIG. 1, the description thereof will be omitted.

In the first embodiment, the case where the extraction unit 42 extracts a rectangular region in which an object is predicted to exist by applying a single threshold to the probability density of each pixel of the density map 55 has been described. In this case, when the threshold is set high, a narrow rectangular region having a high probability density is extracted, and when the threshold is set low, a wide rectangular region having a low probability density is extracted. Thus, in order to be able to extract a rectangular region surrounding a large object, it is conceivable to set the threshold low. However, in a case where a wide rectangular region is extracted by setting the threshold low, in order to detect a large object and a small object at the same time, it is necessary to divide the region cut out from the target image 54 corresponding to the rectangular region in accordance with the input image size of the object detection model 32. As described above, in a case where the input image to the object detection model 32 is divided, there is a possibility that a region indicating a large object is cut, and the region is detected as a plurality of different objects, or the detection itself is not performed.

In consideration of this point, the second embodiment proposes a method for more appropriately reducing detection omission of a relatively large object in an input image by setting a plurality of thresholds.

Next, a functional configuration of the object detection device 210 according to the second embodiment will be described. As illustrated in FIG. 2, the object detection device 210 includes a learning unit 20, an estimation unit 41, an extraction unit 242, and a detection unit 243 as a functional configuration. Each functional configuration is achieved by the CPU 11 reading the object detection program stored in the ROM 12 or the storage 14, loading the object detection program in the RAM 13, and executing the object detection program.

Similarly to the extraction unit 42 of the first embodiment, the extraction unit 242 extracts a region corresponding to a position where the probability density is equal to or higher than a threshold in the density map 55 estimated by the estimation unit 41 for the target image 54 as a region to be a target of object detection. At this time, the extraction unit 242 sets a plurality of thresholds in multiple levels as thresholds for extracting the region to be a target of object detection.

The number of levels of the thresholds in multiple levels and the values of the respective thresholds can be arbitrarily set. A plurality of images may be tried in advance and a combination and the number of thresholds with the highest accuracy may be employed, or in a case where the object detection is performed from the image, the number of stages and the values of the thresholds may be adaptively changed depending on the frame. In the latter case, the number of levels and the values of the thresholds in multiple levels may be set on the basis of the result of extracting the rectangular region and the result of detecting the object for the frame before the target image in the video. For example, the number of levels and values of thresholds in multiple levels may be set so that a rectangular region having a size larger than the size of the object detected in the previous frame is extracted.

In any case, the extraction unit 242 applies the thresholds in descending order of the set thresholds. From characteristics of the correct answer data used for learning of the density estimation model 31, in a case where a large threshold is applied, a region where small objects are densely arranged is extracted, and in a case where a small threshold is applied, a region where a large object exists is extracted. Thus, the extraction unit 242 extracts a small rectangular region when the threshold is large, and extracts a large rectangular region when the threshold is small.

Here, as in the first embodiment, the size of the rectangular region to be extracted is desirably set on the basis of the input image size of the object detection model 32. For example, it is assumed that YOLO v3 having an input image size of 608×608 pixels is used as the object detection model 32, and the thresholds are of three levels. In this case, the extraction unit 242 may extract three types of rectangular regions of 608×608 pixels, 1216×1216 pixels, and 1824×1824 pixels in descending order of the thresholds.

For each of the thresholds in multiple levels, the extraction unit 242 repeatedly performs processing of extracting a rectangular region in order from a higher threshold for all the thresholds. Then, the extraction unit 242 assigns an ID to each of the extracted rectangular regions, and passes rectangular information including the ID, the center coordinates of the rectangular region, and the vertical length and the horizontal length of the rectangular region to the detection unit 243.

As in the first embodiment, the detection unit 243 detects an object by applying the object detection model 32 to the region of the target image 54 corresponding to the rectangular region extracted by the extraction unit 242 on the basis of the rectangle information passed from the extraction unit 242. At this time, the detection unit 243 preferentially employs and outputs a detection result of an object detected from a region of a target image cut out according to a small rectangular region, that is, a rectangular region extracted using a larger threshold. Thus, it is possible to suppress a decrease in detection accuracy of a large object due to object division, and it is possible to detect an object with high accuracy even with a large object.

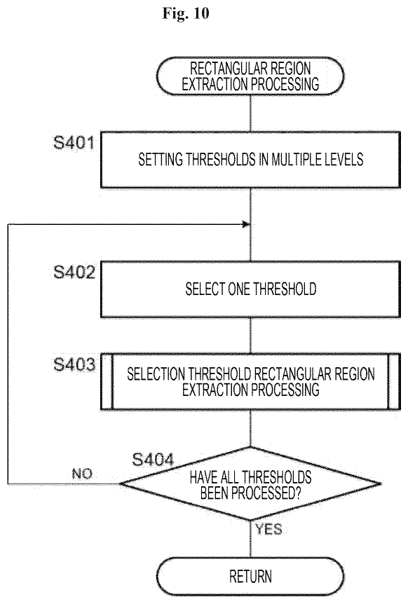

Next, an operation of the object detection device 210 according to the second embodiment will be described. Also in the second embodiment, each of the creation processing illustrated in FIG. 6, the model learning processing illustrated in FIG. 7, and the detection processing illustrated in FIG. 8 is performed. The second embodiment is different from the first embodiment in the rectangular region extraction processing executed in step S310 of the detection process. The rectangular region extraction processing according to the second embodiment will be described with reference to FIG. 10.

In step S401, the CPU 11, as the extraction unit 242, sets the number of levels of thresholds in multiple levels and respective values. Next, in step S402, the CPU 11, as the extraction unit 242, selects one threshold for which the following processing is unprocessed from the plurality of thresholds. Next, in step S403, the CPU 11, as the extraction unit 242, executes selection threshold rectangular region extraction processing for the selected threshold. The selection threshold rectangular region extraction processing is similar to the rectangular region extraction processing (FIG. 9) of the first embodiment. Next, in step S404, the CPU 11, as the extraction unit 242, determines whether or not all the set thresholds have been processed. If there is an unprocessed threshold, the process returns to step S402, and if all the thresholds have been processed, the process returns to the detection process (FIG. 8).

As described above, the object detection device according to the second embodiment sets a plurality of thresholds in multiple levels as thresholds for extracting a region to be a target of object detection from the density map estimated for the target image. Thus, it is possible to extract a rectangular region more suitable for the size of the object, so that it is possible to improve the object detection accuracy in a high definition image or a video.

Note that the creation processing, the model learning processing, and the detection processing executed by the CPU reading software (program) in each of the above embodiments may be executed by various processors other than the CPU. Examples of the processors in this case include a programmable logic device (PLD), a circuit configuration of which can be changed after manufacturing, such as a field-programmable gate array (FPGA), and a dedicated electric circuit that is a processor having a circuit configuration exclusively designed for executing a specific process, such as an application specific integrated circuit (ASIC). In addition, the creation processing, the model learning processing, and the detection processing may be executed by one of these various processors, or may be executed by a combination of two or more processors of the same type or different types (for example, a plurality of FPGAs, a combination of a CPU and an FPGA, and the like). Furthermore, a hardware structure of these various processors is, more specifically, an electric circuit in which circuit elements such as semiconductor elements are combined.

Further, in each of the above embodiments, the aspect in which the object detection processing program is stored (installed) in advance in the ROM 12 or the storage 14 has been described, but this is not restrictive. The program may be provided by being stored in a non-transitory storage medium such as a compact disk read only memory (CD-ROM), a digital versatile disk read only memory (DVD-ROM), or a universal serial bus (USB) memory. Furthermore, the program may be downloaded from an external device via a network.

Regarding the above embodiment, the following supplementary notes are further disclosed.

### (Supplementary Note 1)

An object detection device including:
a memory; and
at least one processor connected to the memory, in which
the processor is configured to
estimate a density map of a target image to be a target of object detection by using a density estimation model that has learned, as correct answer data, a density map indicating a probability density at which an object is present at each position of an image, the density map being created by assigning a predetermined density distribution having a variance corresponding to a size of the object to a position corresponding to a region of the object in a learning image in which the region of the object is known,
extract a region corresponding to a position where a probability density is equal to or higher than a threshold in the density map estimated by the estimation unit as a region to be a target of the object detection, and
detect an object by applying an object detection model generated in advance by machine learning for detecting an object from an image to a region of the target image corresponding to the region extracted by the extraction unit.

### (Supplementary Note 2)

A non-transitory recording medium storing a program that is executable by a computer to execute object detection processing, in which
the object detection processing includes:
estimating a density map of a target image to be a target of object detection by using a density estimation model that has learned, as correct answer data, a density map indicating a probability density at which an object is present at each position of an image, the density map being created by assigning a predetermined density distribution having a variance corresponding to a size of the object to a position corresponding to a region of the object in a learning image in which the region of the object is known:
extracting a region corresponding to a position where a probability density is equal to or higher than a threshold in the density map estimated as a region to be a target of the object detection; and
detecting an object by applying an object detection model generated in advance by machine learning for detecting an object from an image to a region of the target image corresponding to the extracted region.

### REFERENCE SIGNS LIST

Reference Signs List

| | |
|---|---|
| 10, 210 | Object detection device |
| 11 | CPU |
| 12 | ROM |
| 13 | RAM |
| 14 | Storage |
| 15 | Input unit |
| 16 | Display unit |
| 17 | Communication I/F |
| 19 | Bus |
| 20 | Learning unit |
| 21 | Creation unit |
| 22 | Model learning unit |
| 25 | Learning image DB |
| 26 | Learning data DB |
| 31 | Density estimation model |
| 32 | Object detection model |
| 41 | Estimation unit |
| 42, 242 | Extraction unit |
| 43, 243 | Detection unit |
| 51 | Learning image |
| 52 | Density map of learning image |
| 53 | Correct answer data |
| 54 | Target image |
| 55 | Density map of target image |

1. An object detection device, comprising:
a memory; and
at least one processor coupled to the memory, wherein the at least one processor is configured to:
estimate a density map of a target image to be a target of object detection by using a density estimation model that has learned, as correct answer data, a density map indicating a probability density at which an object is present at each position of an image, the density map being created by assigning a predetermined density distribution having a variance corresponding to a size of the object to a position corresponding to a region of the object in a learning image in which the region of the object is known;
extract a region corresponding to a position where a probability density is equal to or higher than a threshold in the estimated density map as a region to be a target of the object detection; and
detect an object by applying an object detection model generated in advance by machine learning for detecting an object from an image to a region of the target image corresponding to the extracted region.

2. The object detection device according to claim 1, wherein the at least one processor is further configured to:
set a plurality of thresholds in multiple levels as the threshold, and extracts a region to be the target of the object detection having a size corresponding to each of the plurality of thresholds.

3. The object detection device according to claim 2, wherein the at least one processor is further configured to:
set a value of a pixel having a probability density equal to or higher than the threshold in the estimated density map to 1, set a value of a pixel having a probability density less than the threshold to 0, and extract a region including a portion in which pixels having a value of 1 are continuous, and having a size corresponding to an input size to the object detection model as the region to be the target of the object detection.

4. The object detection device according to claim 2, wherein, in a case in which each frame of an input video is set as the target image, the at least one processor is further configured to set each of values of the thresholds in multiple levels and a number of levels of the thresholds in multiple levels in a case in which the region to be the target of the object detection is extracted from the target image on a basis of a result of extracting the region and a result of detecting the object for a frame before the target image in the video.

5. The object detection device according to claim 1, wherein the at least one processor is further configured to:
create the density map to be the correct answer data from the learning image and learn the density estimation model using the created density map.

6. The object detection device according to claim 5, wherein the at least one processor is further configured to:
set the density distribution as a normal distribution, and create the correct answer data by assigning, to the density map, the normal distribution in which a difference between a value corresponding to a size of the object and a value of the variance is minimized from among a plurality of normal distributions having different variances.

7. An object detection method, comprising, by a computer:
estimating a density map of a target image to be a target of object detection by using a density estimation model that has learned, as correct answer data, a density map indicating a probability density at which an object is present at each position of an image, the density map being created by assigning a predetermined density distribution having a variance corresponding to a size of the object to a position corresponding to a region of the object in a learning image in which the region of the object is known;
extracting a region corresponding to a position where a probability density is equal to or higher than a threshold in the estimated density map as a region to be a target of the object detection; and
detecting an object by applying an object detection model generated in advance by machine learning for detecting an object from an image to a region of the target image corresponding to the extracted region.

8. A non-transitory computer readable medium storing a program executable by a computer to perform a process for object detection, the process comprising:
estimating a density map of a target image to be a target of object detection by using a density estimation model that has learned, as correct answer data, a density map indicating a probability density at which an object is present at each position of an image, the density map being created by assigning a predetermined density distribution having a variance corresponding to a size of the object to a position corresponding to a region of the object in a learning image in which the region of the object is known;
extracting a region corresponding to a position where a probability density is equal to or higher than a threshold in the estimated density map as a region to be a target of the object detection; and
detecting an object by applying an object detection model generated in advance by machine learning for detecting an object from an image to a region of the target image corresponding to the extracted region.
